(19) United States
(12) Patent Application Publication
(10) Pub. No.: US 2005/0011876 A1
(43) Pub. Date: Jan. 20, 2005

(54) Soldering iron with replaceable tip cap

(76) Inventors: Takashi Uetani, Osaka (JP); Takashi Nagase, Nara (JP); Hiroyuki Masaki, Osaka (JP)

Correspondence Address: Douglas N. Larson;Squire, Sanders & Dempsey, LLP, 14th Floor, 801 S. Figueroa Street, Los Angeles, CA, 90017-5554, US

(21) Appl. No.: 10/855,800

(22) Filed: May 26, 2004

Related U.S. Application Data
(63) Continuation-in-part of application No. 10/719,001, filed on Nov. 21, 2003.

(30) Foreign Application Priority Data
Nov. 26, 2002 (JP) 2002-342823

(51) Int. Cl. B23K 3/02

(52) U.S. Cl. 219/229

(57) ABSTRACT

A soldering iron (and a desoldering iron) with a replaceable tip cap are herein disclosed. The replaceable tip cap is fitted on the forward heat-conducting core end of a soldering (or desoldering) iron heat assembly. Conductive paste, powder or a low melting temperature material such as solder, can be sandwiched between the tip cap and the forward end to improve heat conductivity therebetween. An assembly which allows for the easy removal and application of a replacement tip cap can include a sleeve with tightening bolt, a coil spring sleeve, or a slotted compressible sleeve. The tip cap can thus be replaced after it has worn out, and the heat assembly unit need not be replaced until it has burnt out.

### CROSS REFERENCE TO RELATED APPLICATIONS

This is a continuation-in-part of pending application serial no. 10/719,001, filed Nov. 21, 2003, which claims the benefit of Japanese Application 2002-342823, filed Nov. 26, 2002, and of International application no. PCT/US _ _ _ _ _ _ , filed May 25, 2004 and entitled “Soldering Iron with Replacable Tip Cap.” The entire contents of all of these applications are hereby incorporated by reference.

### BACKGROUND OF THE INVENTION

The present invention relates to soldering iron tips for electric soldering tools and for desoldering tools. It further relates to methods of manufacturing and using soldering iron tips.

Soldering is a method for connecting and bonding components to provide secure electrical connections in the electronics industry. Soldering can be roughly classified into two categories, namely, mass soldering (batch soldering) and manual soldering. Mass soldering includes wave or flow soldering wherein electrical elements or components are mounted on a printed circuit board and then the printed circuit board is passed over a molten solder bath in a manner that allows selective contact with the solder. Mass soldering further includes reflow soldering (SMT) wherein soldered particles and flux are mixed with a binder or additive to form a solder paste. The solder paste is printed on the circuit board, and the elements are then mounted on the circuit board and heated so as to solder them. Both of these methods allow simultaneous soldering of multiple points.

Manual soldering using an electric soldering iron allows an individual user to perform soldering operations. Manual soldering can be used following the mass soldering methods described above, to repair localized defective soldering, or to solder parts which cannot be soldered with the mass soldering methods.

Conventional soldering iron tips for electric soldering irons are made of copper or copper alloys and their forward ends are iron plated to a thickness of from thirty to fifty micrometers up to five hundred to eight hundred micrometers, in order to prevent solder corrosion of the copper. This iron-plated area is then coated or wetted with solder, and soldering operations are performed therewith.

In the past it was common for the principal components of solder to be tin and lead (Sn—Pb solders of which Sn—Pb eutectic solder is representative thereof. However, in recent years due to environmental concerns, lead is less commonly used and so-called lead-free solders have been more frequently used. Examples of lead-free solders are Sn—Cu solders, Sn—Ag solders, and Sn—Ag—Cu solders.

As compared to Sn—Pb solders, it is more difficult to achieve good solder joints with lead-free solders, due to inferior solder wetting and the difficulty of solder spreading. The primary causes of inferior solder wetting include the facts that the melting points are 20° C. to 45° C. higher than Sn—Pb solders and the iron tips of the soldering irons are more readily oxidized. Consequently, soldering work using manual soldering methods has suffered. Soldering defects are more likely to result with manual soldering which uses lead-free solder and thereby more frequent repairs are required. The present applicants have invented technology for improving soldering performance while maintaining substantially the same degree of solder corrosion durability of the soldering iron tip as prior iron plated soldering iron tips experienced with leaded solder. This is described in patent document A JP-2000-317629, entitled “Soldering Iron Tip” and filed on May 10, 1999. As described in this document, instead of conventional iron plating, an Fe—Ni alloy plating is used at the forward end of the soldering iron tip, or an Fe—Ni alloy covering member (a bulk material) is provided to improve soldering performance.

Furthermore, soldering related operations include desoldering wherein (electric) solder suction devices are used to remove undesired solder. These devices have a suction nozzle that is heated such as by a built-in heater, and the end of the heated suction nozzle is contacted with the solder to thereby melt it. The molten solder is suctioned into the interior of the desoldering tool through an opening at the end of the suction nozzle. The suctioning is performed by a vacuum pump or the like, and the molten solder is stored in a tank (or a capsule) having a filter provided in the suction passageway thereto.

With respect to the function of melting solder when the heated tip contacts the solder, and the requirement of good solder wetting in order to maintain good heat transfer characteristics, the suction nozzle of the electric solder suction device is similar to the soldering iron tip of an electric soldering iron, and similar iron plating is typically used at the forward end thereof. Similar to the soldering iron tip of the electric soldering iron, desoldering tip corrosion is to be prevented and solder wettability is to be maintained, even when using lead-free solder.

The tips of soldering irons wear out quickly, and therefore most industrial soldering irons are designed so that the tip can be replaced as needed instead of always replacing the entire soldering iron when the tip erodes or otherwise wears out. There are basically three different types of replaceable tip designs in the prior art.

The first type is one where an elongate tip is releasably held inside an elongate heater. An example thereof is disclosed in U.S. Pat. No. 5,422,457 (Tang et al.). (This patent and all other patents, publications and applications mentioned anywhere in this disclosure are hereby incorporated by reference in their entireties.)

The second type is shown, for example, in U.S. Pat. No. 5,248,076 (Eisele et al.). It includes a tip which is fitted over a temperature sensor and heater extending out from the soldering iron body.

The third type is shown in U.S. Pat. No. 6,054,678 (Miyazaki) and U.S. Pat. No. 6,215,104 (Kurpiela et al.). The constructions shown therein are an entire heating unit including the tip sensor and heater, which are built as a one-piece device for better heat transfer than that of the second type. The entire unit is replaced when the tip, which can be a copper tip with an iron plating, becomes worn out. The unit can be pressed into a sleeve or pushed into a socket; and in other words, it is a composite tip having a built-in heater.

The soldering tips of the first two types have structures where the tips are either positioned into an opening in a heater as in the first type, or positioned onto a heater as in the second type. The heat for the soldering operation is conducted from the heater through the tip to the work area. The structures of these two types have a clearance or gap between the heater and the tip. Thus, the heat conduction is less than that of the soldering iron of the third type, which has a tip heater composite structure. Disadvantageously, the replaceable composite heater assembly of the third type has a high operating cost, because when the tip wears out the heater and sensor units must also be replaced.

### SUMMARY OF THE INVENTION

A soldering iron or desoldering iron with a replaceable tip cap is herein disclosed. A replaceable tip cap is fitted on the forward heat conducting core end of a soldering or desoldering iron heat assembly. Conductive paste, powder or a low melting temperature material such as solder, can be sandwiched between the tip cap and the forward end to improve heat conductivity therebetween. An assembly which allows for the easy removal and application of a replacement tip cap can include a sleeve with tightening bolt, a coil spring sleeve, or a slotted compressible sleeve. The tip cap can thus be replaced when it finally fails, and the heat assembly unit need only be replaced when its performance degrades. For example, the tip cap can be replaced after between approximately 10,000 and 40,000 point soldering uses and the heat assembly unit after between approximately 10,000 and 40,000 point soldering uses.

The tip cap can be a metal particle sintered cap which includes a sintering base material, or a sintering base material and a sintering additive, wherein the sintering base material includes iron, nickel and/or cobalt particles. By using a sintered alloy having as its primary components iron, nickel and/or cobalt (which are elements from the same group having properties similar to iron), or a combination thereof, a soldering iron tip cap can be produced having good resistance to solder corrosion and good solder wettability. In particular, when the sintering materials are based on iron particles to which nickel particles are added, improved corrosion resistance and solder wettability as compared with iron particles alone can be obtained.

The above-mentioned iron particles used for the sintering base material can be iron powder preferably having a purity above 99.5%. Losses in thermal and electrical conduction and inferior soldering application characteristics or soldering removal characteristics due to impurities are thereby avoided. On the other hand, the density of the metal particle sintered body or member is advantageously increased. If the iron particles contain large quantities of impurities, such as carbon, oxygen, nitrogen or hydrogen, the corresponding density of the metal particle sintered member may be only about 90%; while if high purity iron particles are used, the resulting density is increased to 96% or greater.

The sintering base materials (iron particle, nickel and/or cobalt) in the metal particle sintered tip cap can comprise between 60% and 99.99% by weight percentage of the tip cap. This allows the properties of the sintering base material, which serves as the primary component, to be effectively used. Solder corrosion resistance and solder wettability are thereby significantly improved.

The metal particle sintered cap can include a sintering base material and a sintering additive wherein the additive is selected from the group of copper particles, silver particles, tin particles, boron particles and carbon particles. This allows not only for further improved soldering performance but also for a high density metal particle sintered body or member to be produced by sintering at relatively low temperatures and for the body or member to have good corrosion resistance. Copper, silver and tin have relatively low melting points, namely 1,083° C., 961° C., and 232° C., respectively, and can be used. Thus, even if the sintering temperature is set to a relatively low temperature, at least the tin particles melt in the sintering process, allowing liquid phase sintering, which fills in the gaps between the particles. In solid phase sintering, boron is interstitially diffused among the iron group elements, furthering mutual diffusion of the solids within each other, allowing sintering at a relatively low temperature of 1,100° C. Carbon when included can improve the solder corrosion resistance and significantly extends the working life of the tip.

The content of the sintering additive in the metal particle sintered cap can be between 0.01% and 40% by weight percent. Thereby, it is possible to establish the optimal amount to be added without the amount of the sintering additive being too small and its effect being insufficient and without being too large, resulting in defects.

The tip cap alternatively can be provided as a replaceable suction nozzle on a main body similarly provided with a heating element and also with a vacuum function. With the electric soldering iron or the electric desolder tool thereby produced, it is possible to reduce the number of times that the soldering iron tip is replaced when applying or removing lead-free solder. Additionally, this construction provides for increased workability and also facilitates high quality soldering and solder removal even by people who are not highly skilled.

In addition to the soldering iron tip cap construction, another invention herein is the method of manufacturing of soldering iron tip caps for handling solder. The sintering base material or the sintering base material and the sintering additive, can be mixed with a binder. The binder materials would be mixed with the sintering base materials and sintering additives to an amount of approximately forty volume percent, or ten to forty weight percent. A shape substantially the same as the desired soldering iron member or a shape encompassing the shape thereof, is formed as a green compact by pressure molding. The green compact is fired in a non-oxidative (an inert gas) atmosphere at 800 to 1,300° C. to produce the desired metal particle sintered cap construction.

A step in the manufacturing process of the metal particle sintered cap is to further shape it by preform forging or powder forging at temperatures of 300° C. to 500° C. to produce the soldering iron forward member. This reduces the fine air cavities between the particles and the metal particle sintered cap, thereby increasing the density and improving corrosion resistance.

Further, instead of pressure molding, injection molding methods can be used to form the soldering iron tip cap. In this manner, a green compact can be easily shaped, even for relatively complex shapes that are difficult to make by compression molding. The need for subsequent machining is thereby reduced or eliminated and manufacturing productivity increased.

Liquid phase sintering can alternatively be used according to the present invention. Liquid phase sintering includes the firing temperatures being no less than the melting point of the sintering additive. This allows for high density metal particle sintered caps to be produced by sintering at a relatively low temperature. In other words, with liquid phase sintering, the particles having a lower melting point, melt in the sintering process and fill in the gaps between the metal particles. Thereby, a high density metal particle sintered cap can be produced, allowing for excellent solder application characteristics and solder removal characteristics. A power savings is also achieved since the sintering is at relatively low temperatures.

Another method of manufacturing a soldering iron tip cap of the present invention includes alloying the sintering base material and the sintering additive by a solution process and granulating the particles to produce an alloy particle. The metal particle mixing process thereby can be simplified, increasing manufacturing productivity.

A further manufacturing method of the invention is characterized in that the particle size of the sintering base material, the sintering additive or the alloy particle used is no greater than 200 μm. Alternatively, the particles used can be no greater than 50 μm. Even further, ultra-fine particles can be used as the sintering base material, the sintering additive or the alloy particle. By using small metal particles, the final density of the metal particle sintered body can be increased. Additionally, it is possible to improve the solder application characteristics or the solder removal characteristics, and to improve the corrosion resistance of the soldering iron tip.

However, it is difficult to form a tip cap whose thickness is less than approximately one thousand microns using pressing or extruding processes. Also, the density of caps formed using these methods will generally be ninety percent or less. Therefore, it is preferable to use metal injection molding to form the tip cap of this invention. Using this method, the tip caps can have a wall thickness of two hundred to eight hundred microns and a density after sintering of 96 to 97%.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a cross-sectional elevational view of a soldering iron of the present invention;

FIG. 2 is an elevational view of the heating assembly of the soldering iron of the FIG. 1 illustrated in isolation;

FIG. 3 is an exploded perspective view of the forward portion of the heating assembly of FIG. 2;

FIG. 4 is a first alternative of the heating assembly of FIG. 2;

FIG. 5 is an exploded perspective view of the forward portion of the heating assembly of FIG. 4;

FIG. 6 is a second alternative of the heating assembly of FIG. 2;

FIG. 7 is an exploded view of the forward portion of the heating assembly of FIG. 6;

FIG. 8 is an enlarged exploded view of a forward end of the heating assembly showing the tip cap and conductive material in cross section;

FIG. 9 is an elevational view of a first alternative tip cap of the present invention;

FIG. 10 is an elevational view of a second alternative tip cap;

FIG. 11 is an elevational view of a third alternative tip cap;

FIG. 12 is an elevational view of a fourth alternative tip cap or the tip cap of FIG. 1;

FIG. 13 is a cross-sectional view taken on line 13-13 of FIG. 12;

FIG. 14 is an elevational view of a fifth alternative tip cap;

FIG. 15 is a cross-sectional view taken on line 15-15 of FIG. 14;

FIG. 16 is a graph showing heat characteristics with and without the tip cap heat conductive material such as shown in FIG. 8;

FIG. 17 is a graph showing temperature characteristics;

FIG. 18 is an enlarged cross-sectional view of a forward end of a desoldering iron of the present invention using a removable desoldering tip cap; and

FIG. 19 is an alternative of the desoldering iron of FIG. 18.

### DETAILED DESCRIPTION OF PREFERRED EMBODIMENTS OF THE INVENTION

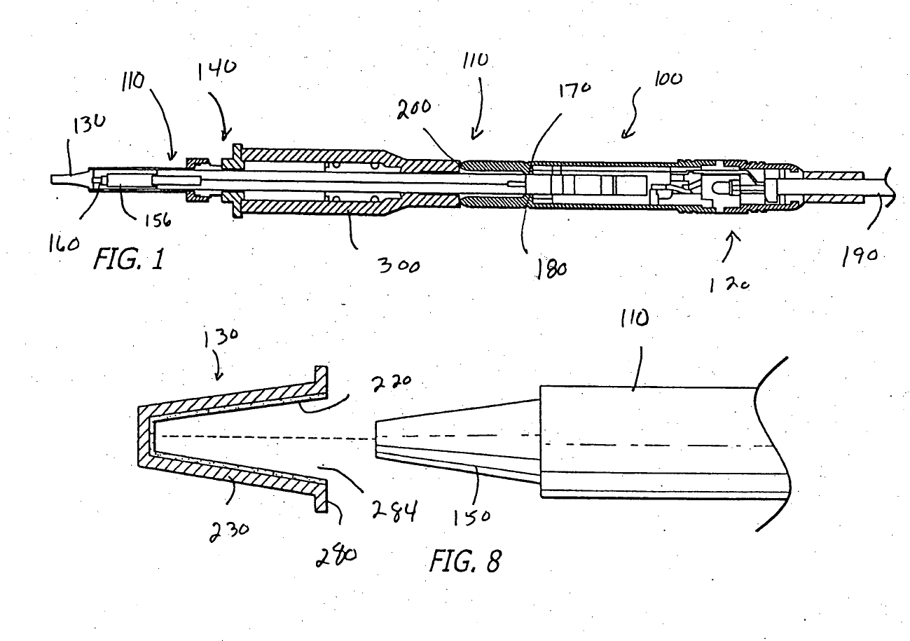

Referring to FIG. 1, a soldering iron of the present invention is illustrated generally at 100. Soldering iron 100 includes a heating assembly 110 (or heating unit) shown generally at 110, a connector assembly 120, a replaceable soldering iron tip cap 130, and a holding assembly 140 for releasably holding the tip cap 130 on the tapered working tip 150 of the copper or copper alloy 154 of the heating assembly 110. The heating assembly 110 also can include a heating unit 156 and a temperature sensor 160. The heating assembly 110 is removable from the connector assembly 120 for replacement purposes. It is snap fit into the forward end of the connector assembly 120 and held therein, for example, by an O-ring 170. The soldering iron 100 of FIG. 1 and its construction, components and operation, can perhaps better be understood from U.S. application Ser. No. 10/264,718, filed Oct. 4, 2002, and entitled “Iron Tip And Electric Soldering Iron” and U.S. application Ser. No. 10/686,439, filed Oct. 14, 2002, and entitled “Cartridge Style Cartridge Type Soldering Iron.” The tip cap invention described herein can be used on many other prior or existing soldering irons as would be apparent to those skilled in the art. Examples of two of them are disclosed in U.S. application Ser. No. 08/798,467 entitled “Soldering Iron Tip and Its Producing Method,” U.S. Pat. No. 5,579,833 (Wijkstrom), and U.S. Pat. No. 6,386,423 (Alder).

The O-ring 170 snaps into a slot 180 on the end of the heating assembly 110. When inserted into the connector assembly 120, the heating assembly 110 is electrically coupled through the connector assembly 120 to a power supply via a power cord 190. The connector assembly 120 has a receptacle opening 200 which has both the O-ring 170 and electrical contacts in it. The user thereby can insert the heating assembly 110 into the receptacle opening until electrical contact is made. Then the heater assembly 110 is held therein with O-rings 170 within the slot. To release the heater assembly 110 from a receptacle opening 200 of the connector, the user pulls it out. This is shown, for example, in U.S. Pat. No. 6,710,305 (Lindemann, et al.). Heat conductive material 220, as shown in FIG. 8 and described later in this disclosure in detail, on the inside surface of the tip cap 130, provides excellent thermal conduction from the working tip 150 to the tip cap 130.

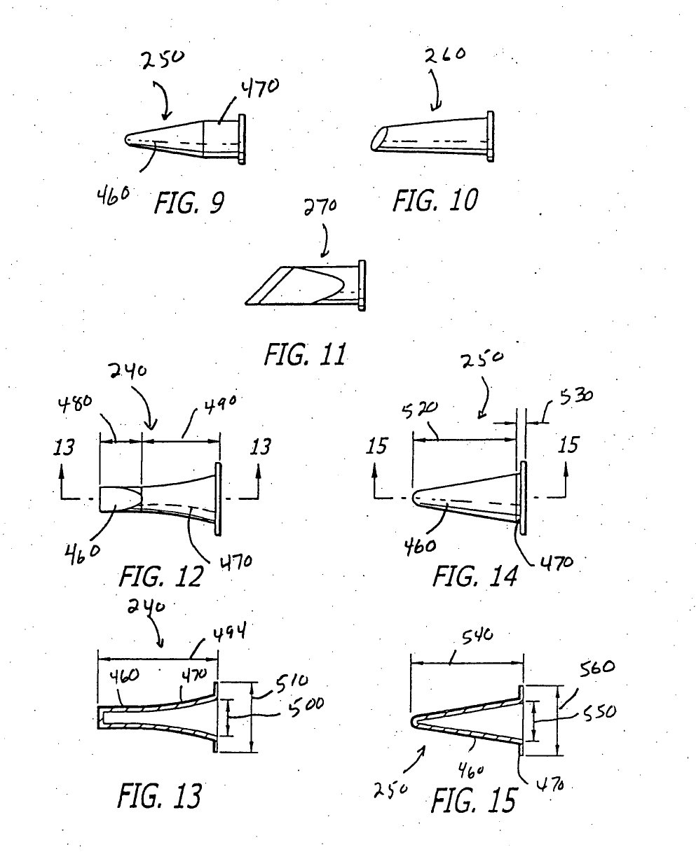

The tip cap 130 includes an upper portion or crown portion 230 having a thin wall of substantially constant thickness and whose interior and exterior surfaces are shaped to conform to the outside surfaces of the working tip 150. The upper or crown portion 230 can be configured in any shape known or apparent to those skilled in the art such as: a chisel type shape 240 as shown in FIGS. 12 and 13; a conical shape 250 as shown in FIGS. 9, 14 and 15; a beveled shape 260 as shown in FIG. 10; and a knife-shape 270 as shown in FIG. 11. A lip, flange or rim 280 as shown, for example, in FIG. 8 extends out from the base of the crown portion 230 and preferably extends the full circumference thereof, around the base opening 284. However, it is also within the scope of the present invention to omit the flange or to provide one or more spaced tabs in lieu of a continuous circumferential flange.

The heating assembly 110 also includes a circumferential grip or handle 300. The grip or handle 300 can be made of rubber, elastomers and plastics and a preferred material is a plastic material mixed with a antivirus material. This is described in U.S. Pat. No. 6,710,304 (Yokoo), as well as in U.S. patent application Ser. No. 10/348,684, filed Jan. 22, 2003.

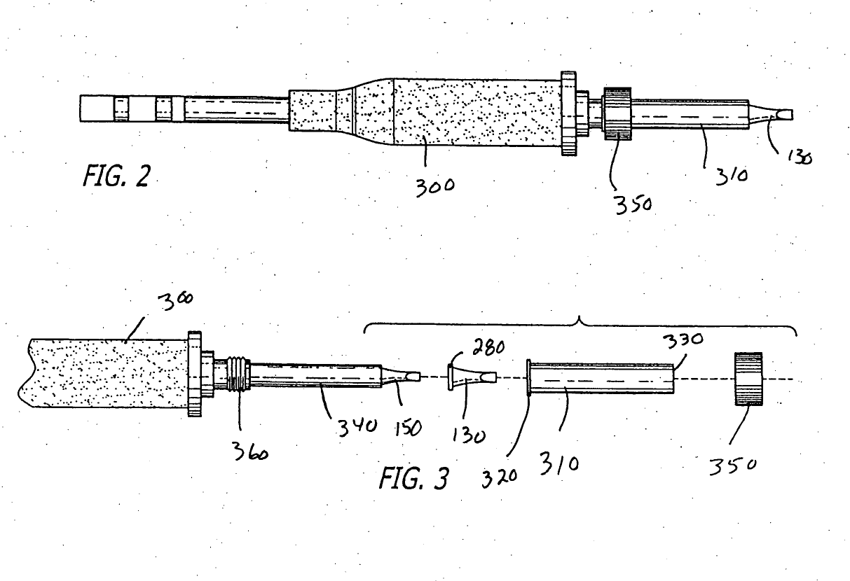

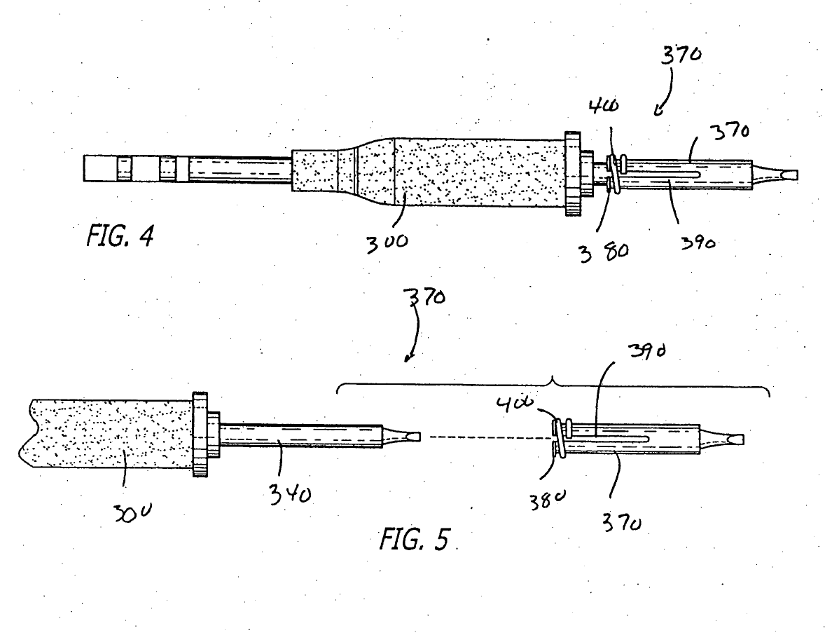

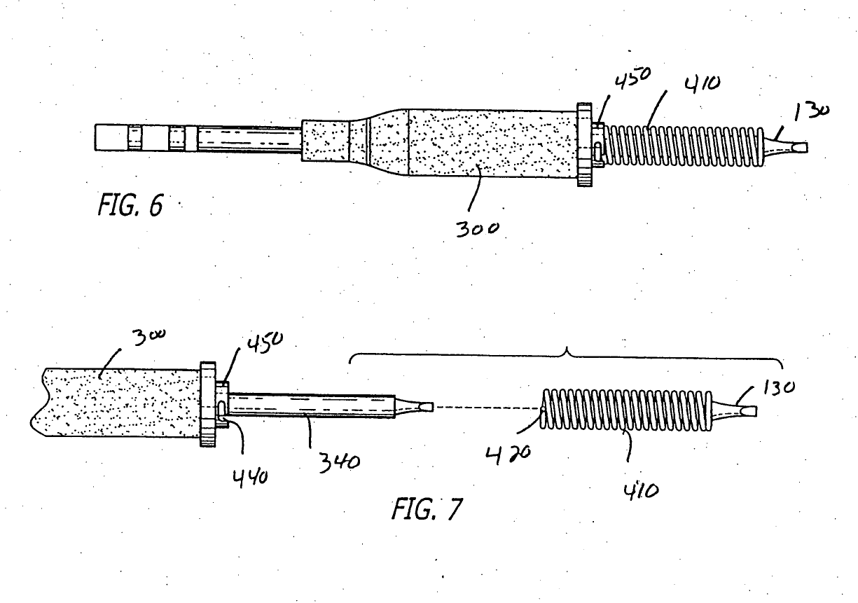

The holding assembly 140 holds the tip cap 130 firmly to the working tip 150 so that excellent heat conduction is provided through the conductive material 220 sandwiched therebetween. Further, the holding assembly 140 is designed such that the tip cap 130 can be easily removed by a user when worn through erosion and replaced with a new tip cap. A preferred assembly of holding the tip cap 130 on to the working end 150 is best shown in FIGS. 2 and 3. Referring thereto, a sleeve 310 having a proximal flange 320 is provided. The sleeve 310 has a length and an inner diameter sufficient to enclose the heating unit 156; and for example, the length can be between 10 mm and 100 mm, and the diameter can be between 3 mm and 20 mm, and the sleeve can be made of stainless steel. At its forward end, the sleeve has inwardly projecting tabs or flanges.

To fit the tip cap 130 in place on the working tip 150, reference is now made to FIG. 3. The sleeve 310 is slid to the left of that figure over the tip cap 130 and then over the slender rod portion 340 of the working end 150 of the heating assembly 110. The lips or tabs 330 of the sleeve 310 engage the flange 280 of the tip cap 130 and pulling the tip cap 130 onto the working end 150. A nut 350 is then slid over the tip cap 130 and the sleeve 310 and then threaded onto the threaded portion 360 of the heating assembly 110 as seen in FIG. 3. When threaded in place the tip cap 130 is firmly held as shown in FIG. 2 on the working end 150. To remove the tip cap 130 after it is worn through soldering use, the nut 350 is unscrewed and the nut, sleeve 310 and tip cap 130 are removed. A replacement tip cap can then be fitted in place.

A first alternative holding assembly is the compressible gripping sleeve shown at 370 in FIG. 5. Referring thereto, it can be seen that the sleeve 370 has a rearward flange 380 and a one or more longitudinal slots 390 which engage the flange 380. The tip cap 130 is preferably affixed to the front end of the sleeve 370. A short coil spring 400 can be affixed to the rear portion of the sleeve 370. This sleeve 370 and tip cap 130 are slid into place along the rod portion 340 of the heating assembly 110 and the radial flexure of the slotted sleeve 370 and the gripping of the coil spring 400 hold the sleeve in place on the rod 340. To remove the tip cap 130, the sleeve 370 and tip cap combination are pulled off, slid off, of the working tip 150 by the user and replaced with a new one. Alternatively, the tip cap 130 and sleeve 370 can be separable components.

A further alternative is a compressible member 410, preferably an elongated coil spring, which can be secured at its forward end to the flange 280 or the rearward portion of the tip cap 130. The coil spring 410 has a coil spring end tab 420 at its rearward end. To install the tip cap 130 on the soldering iron the spring tip cap unit as shown in FIG. 7 is slid onto the rod portion 340 and the end tab 420 of the coil spring 410 is fitted into the L-angled slot 440 on the collar 450 of the heating assembly 110, and pressed inwardly against the bias of the spring 410 and rotated into the L section of the slot. When the spring 410 is then released from its compressed state, the spring is held by tension in the slot 440 and the tip cap 130 is thereby releasably held in place on the working end tip 150. Alternatively, but less preferably, the coil spring 410 and tip cap 130 can be made as two separate components which are fitted and connected together by suitable means.

The length of the tip cap 130 can be 5 mm to 20 mm. It is preferably not longer than 20 mm since a strain is subjected to it during the sintering manufacturing process and the cost of the die needed to make it becomes expensive. For most shapes, the outer diameter of the base opening 284 is about 2 mm to 10 mm. The thickness can be approximately 2 micrometers to 800 micrometers. It preferably has a solder plating 460 on its working surface. This solder plating 460 can, for example, be a tin plating. The rearward non-working portion of the tip cap 130 can be chrome plated 470 to prevent the solder coming up past the effective working area of the tip cap 130. The tin plating 460 can be done before the chrome plating 470 or after, or the tin plating may be performed by a user.

For a chisel type configuration such as shown in FIGS. 12 and 13, the solder plating 460 thereon can extend rearward distance 480 of 4 mm but can vary from 1 mm to 10 mm. A preferred dimension is 4 mm with chromium plating 470 extending a distance 490 of 6 mm for a total length 494 of 10 mm as shown in FIG. 13. The interior diameter 500 can be 4 mm and the exterior diameter 510 of the flange can be 5 mm. For the conical tip type, as shown in FIGS. 14 and 15, the dimensions can be 6.5, 0.5, 7, 2.5 and 3.5 as depicted by reference numerals 520, 530, 540, 550 and 560, respectively.

The thin tip cap 130 can be made by metal injection molding or by press forming methods. These methods and various preferred and alternative materials are described later in this disclosure.

It can be appreciated that the interior surface of the tip cap 130 and the exterior surface of the working tip 150 must be the same shape and dimensions. Even under exacting manufacturing techniques, gaps will exist if the tip cap 130 is simply fitted on the working tool tip. These gaps reduce the heat conductivity. To manufacture the cap precisely and with no resulting gaps would be cost prohibitive. Further, because the soldering iron 100 is used under high temperatures of around 300° C. to 400° C., metal diffusion will occur at the contact areas and the two will join so that the cap 130 cannot be subsequently removed from the tool tip 150.

Consequently, the present invention advantageously and uniquely provides for the heat conductive material 220 (FIG. 8) to be sandwiched between the tip cap 130 and the working tool 150. The heat conductive material 220 provides for full heat conductive contact between the cap 130 and the working tool 150, filling in all of the gaps therebetween. The heat conductive material 220 also prevents the cap 130 from contacting the tool 150 and the consequent possibility of metal diffusion occurring.

Sufficient quantity of heat conductive material 220 needs to be provided to fill in this gap. For example, the material 220 can be such as to fill in a 0.1 mm gap around a 4 mm diameter tool working end and along a 9 mm length of the cap 130. Thus, when the conductive material 220 is lead having a specific gravity of 11.34, the amount of the heat conductive lead material will be 0.14 gram. The preferred range can be between 0.01 gram to 10 grams, and more preferably the range can be 0.1 to 1 gram. It is difficult, though, to measure the precise amount needed. Further, the specific gravity will differ according to the material or the amount used according to the size of the gap.

There are basically two types of heat conductive materials 220 which can be used. One is the type that melts during use and the other is the type that is solid during use. The type that melts during use, such as solder, more easily covers the gaps. It, however, has the problem that the tip cap 130 needs to be replaced when the solder is in a melted state. This is because the solder solidifies when the temperature drops to room temperature and the tip cap 130 cannot be then removed and replaced. Examples of heat conducting materials 220 that melt during use are SN (melting point 232° C.) (hereafter M.P. 232C), SN-37PB (M.P. 183C), BI (M.P. 271C), SN-0.7CU (M.P. 227C), SN-3.5AG-0.7CU (M.P. 217C), SN-9ZN (M.P. 198C), SN-58BI (M.P. 138C), IN (M.P. 156C), and PB (M.P. 237C). These metals and metal alloys are generally called solders (except for Bi and In) and are commercially available as in line solders or paste solders. When these materials are used it is better that they be in a powder or paste state when applied. The preferred melting temperature is 100° C. to 350° C. Lower melting temperatures are preferred to prevent the user from burning himself when replacing the tip. More important than the melting temperature, is that the material 220 not react easily with certain metals since they contact the cap inner surface when melted or material that oxides quickly such as SN-9ZN.

The conductive material 220 can be in a number of forms when applied to the inner surface of the tip cap 130. (Alternatively, where appropriate the material can be applied to the tip surface of the working tool 150 in lieu of or in addition to application to the inside of the tip cap 130). The material can be a metal with a low melting temperature, such as solder. For the metal state, there are many paste solders that are mixed with flux and are commercially available. It can be in a powder form such as carbon, aluminum, copper or silver particles, and having a heat conductivity of between 0.01 and 1.0 (0.4814W/mK). When in the powder form the particle size is preferably one to twenty micrometers. A third state is in a gel form having a good heat conductivity. The gel composition can be made by adding organic solvents such as alcohol, oil, flux or paraffin wax to the conductive material 220 to make it into a gel or a paste state. A paste or a gel type is easier to handle than a powder type when applying to the cap.

When the conductive material 220 is in a powder state, it can be inserted into the tip cap 130 using a utensil such as a spoon or in a tablet form using one or more tablets. When the conductive material 220 is in a paste state, it can be applied from a squeeze tube, from an injection syringe, from a dropper or using a cotton swab. After the gel has been inserted into the tip cap 130, the cap is pressed onto the end of the working tip 150 until the all the gaps therebetween are filled.

The heat conductive material 220 is generally easier to apply when in a gel state than when in a powder form. For example, the squeeze tube is first filled with material 220 and then the tube is squeezed to insert the gel material into the cap 130. It is preferable to apply excess material and then wipe off the excess heat conductive material 220 oozing out from the sides at the end of the cap than to not apply enough material.

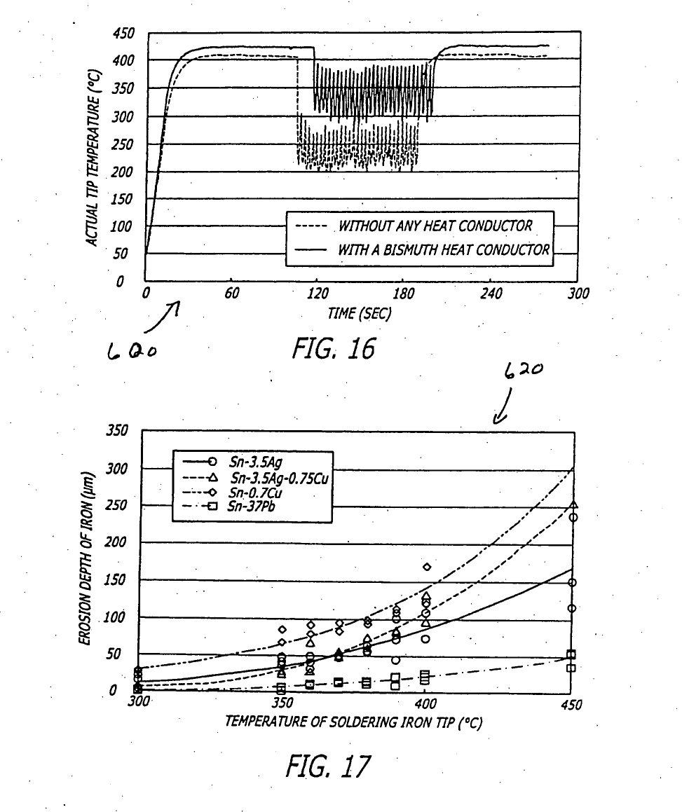

The importance of providing the conductive material 220 can be understood from the graph as shown generally at 600 in FIG. 16. Referring thereto, the tip temperature with respect to time using the heat conductor (the solid line) and without using the heat conductor (the dotted line) are shown with the tip cap invention herein.

Graph 600 was prepared from the results of the following tests. The actual tip temperatures of a MIM tip cap (Type T7-2.4D) using the same soldering iron were measured. Specifically, one sample had the MIM tip cap (130) fixed directly on the core working end tip without using any heat conductive material. The other sample used bismuth heat conducting material between the MIM tip cap and the working end tip. Sn—Pb eutectic solder wire having a 1.6 mm diameter was used. The cap temperature was controlled by setting the soldering iron at approximately 406° C. under the cap without any heat conductor. Five millimeters of soldering wire were fed at a single soldering. The soldering cycle was three seconds and the soldering frequency was thirty times. The soldering work was done on a one centimeter by one centimeter piece cut on the copper surface layer of a copper-clad, paper-base phenolic-resin printed wiring board (Sunhayato Brand #16). The temperature was measured by an Alumel-Chromel thermocouple spot welded about two mm from the cap tip.

As can be seen from graph 600, the sample which uses the conductor is superior to the other sample because (1) the start-up speed is faster; (2) the maximum temperature is higher by about 16° C.; and (3) the temperature drop during soldering is less.

The smaller temperature drop is preferred. Generally, the tip temperatures are set between 350° C. to 400° C. Using for example solders that use 380° C., a greater effort is needed to lower the tip temperature even just 10° C.

It is known that when a higher tip temperature is used, a greater amount of erosion in the tip results, making for a shorter working life for the tip. This is shown in the graph 620 of FIG. 17. For example, for Sn-0.7Cu when the tip temperature is lowered from 400° C. to 350° C., the amount of erosion is reduced by half. This makes it possible to extend the tip life of approximately twice as long. This characteristics applies not only to iron plated tips but also to (MIM) tip caps 130, such as those of the present invention. Generally any metal tip will have the characteristics as shown in the graph.

When the tip temperature is lowered, the problems of wetting and oxidizing the tip also improve. When soldering at high temperatures metallic compounds, between the cover pattern circuit and the tin; for example, are more likely to grow thicker. The Cu6Sn7 compounds grows inside the solder joint and the joint becomes less reliable. At best, soldering at lower temperatures has many advantages. This is described in detail as is the graph 620 of FIG. 17 in the Japanese article entitled “Damages of Soldering Iron by Lead-Free Solder and How to Reduce Damages of the Soldering Iron.” The article was announced at the 10th Symposium on “Microjoining and Assembly Technology and Electronics” on Feb. 5, 2004, which was sponsored by Microjoining Commissions in Japan Welding Society. The article was published in “Proceedings of the 10th Symposium on Microjoining and Assembly Technology and Electronics,” Vol. 10, 2004.

One of the advantages of a MIM tip cap 130 is that it can be used with a variety of solders including lead-free solders. The preferred material composition of the tip cap will vary according to the user's needs. The materials should have good wetability by solder as well as good resistance against erosion by molten solder. An example is a MIM tip cap that has a good wetability. Some MIM cap tips will have a better wetability but shorter working lives than ordinary tips made of iron plating. Others will have better working lives, but less wetability than ordinary tips made of iron plating.

There are two preferred materials. Materials that have good solderability include (a) Fe-2 wt. % to 50 wt. % Ni alloy (Iron-Nickel Alloy manufactured by MIM and sintering ). Preferably Fe-10 wt. % Ni (Iron—10 weight percent nickel Alloy) (b) Fe-0.5 to 10 wt. % Cu-0.1 to 5 wt. % Ni-0.1 to 1.0 wt. % Ag Alloy (Iron-Copper-Nickel-Silver Alloy manufactured by MIM and sintering); preferably Fe-1 wt. % Cu-0.4 wt. % Ni-0.3 wt. % Ag (Iron—1 weight percent Copper—0.4 weight percent Nickel—0.3 weight percent silver Alloy). And materials that have good antierosion characteristics are Fe-0.05 to 1 wt. % C (Iron-Carbon Alloy manufactured by MIM and sintering); preferably Fe-0.4 wt. % C (Iron—0.4 weight percent Carbon Alloy).

In the past, to prevent the solder from extending up a soldering iron tip, which made the soldering less ineffective and less accurate, the tip was processed with chromium plating at the rearward of the working tip end. Unfortunately, after a number of soldering operations, the chromium plating gradually corroded or eroded as the tin in the solder ate the chromium plating (as well as the iron plating). Further, most of the active agents in flux contain chlorine which can also corrode the chromium plating. Thus, the chromium plating portion of the soldering tip according to the prior art can be eaten away, not only by the chlorine flux, but also by the tin solder. Additionally, it was difficult for the chromium plating to be applied without a gap between the soldering tip and the plated material. Further, chromium VI that is used for chromium plating is known to cause cancer and damage the health of humans and other living things.

Accordingly, the present invention provides for an alternative to the chromium plating of the prior art. Specifically, a flame or a plasma spray coating is used to spray various materials such as ceramics, cermet, and metals having high melting points on the working tip 150. Metals which perform well and have good adhesion to the copper core include SUS316 stainless steel and molybdenum (Mo). Examples of ceramics showing good performance are: Al2O3—2.5% TiO2, 62% CaO—33% SiO2, ZrO2—8% Y2O3, 70% Al2O3—29% MgO, Al2O3—40% TiO2, ZrO2—20% MgO, Cr2O3, ZrO2—4% CaO, and ZrO2—CeO3.

When using ceramic coating or plating, the adhesion and corrosion resistance of the ceramics can be improved if an undercoating is first applied. Examples of the undercoating are Ni—Cr, SUS316, Cr—Mo. Thermal spray coating may make the material porous, and a sealing coating can be used to close the holes.

Since the temperature of flame spray coating is generally too low to spray ceramics or high melting point metals, plasma spray coating is the preferred application technique.

The soldering iron tip can have a copper or copper alloy core having a base portion and the forwardly-extending portion 150. The end of the forwardly-extending portion can have the tip cap 130 of the present invention releasably applied thereto. The soldering iron tip 150 is first cleaned by degreasing, that is taking oil off its surface using acetone and/or a degreasing agent.

The surface of the soldering iron tip 150 is then roughened using steel grit blasting. The diameters of the steel grit particles are approximately 10-250 μm, preferably with an average of 80 μm and having a 10 Morse hardness. The output of the blast machine can be approximately between 3.7 to 4.0 kgf/cm2, and the steel grit particle blast can be for about ten seconds. After the blast, the surface on the soldering iron tip can be cleaned to purge the steel from the surface since if steel is left on the surface the surface can rust. The cleaning can be done by jet air blasts.

To apply the plasma spray coating, the soldering iron tip 150 can be installed on a spinning machine and spun at between 50 and 500 rpm. The injection nozzle for the sprayed material can be positioned about one hundred millimeters from the spinning soldering iron tip. The temperature of the inside of the injection nozzle reaches 1,000 to 10,000 degrees Centigrade. The spraying can be done for about three cycles traveling right and then traveling back to the left from one edge of the base soldering iron tip core to the other. For example, when SUS316L is used as a spray coating material, the base material would have a 20 μm layer of SUS316L deposited for each cycle.

An undercoating can be applied to the surface of the base material to provide a stronger adhesion of the plasma-sprayed top coating material. If ceramic material is sprayed on the metal (copper) base material, the adhesion to the metal surface of the base material can be weak. This is especially true if the product used for the ceramic top coating is used under high temperatures (such as a soldering) and may cause exfoliation because of the difference of the expansion rate against the heat. Therefore, the material used for the undercoating should have an expansion rate which is between that of the top coating and that of the base material (e.g., copper). Ni-20% Cr can be used for the undercoating material. Alternative materials which can be used for heat resistance undercoating are (1) Ni, Co23%, Cr17%, Al2%, Y0.5% and (2) Co, Ni32%, Cr21%, Al8%, Y0.5%. The undercoating can be applied using the same technique as that for the top coating as described above.

Flame spray coating or plasma spray coating of a material may cause the sprayed material to be porous. To close or cover the holes specific coating agents can be used herein as a sealant. Examples are SiO2 and ZrO2, and they can be hardened by heating them at 180° C. for thirty minutes.

In addition to SUS316 and Mo, Al, Ni, Cu, W, Ti perform well as the coated metal material. The workable metals should be durable as to chlorine flux, not eaten away by tin solder and be capable of being plated without any gaps between the soldered tip and the plated material. The material also should not have wettability as to solder. Materials such as SUS316 and Ti have a strong oxidation film on their surface. Therefore, these materials do not make metallic compounds with the tin of the solder because of no wettability. These types of metals can be used as the material of the film having no wettability. All ceramics do not have wettability with solder. However, metals are superior to ceramics at the point of adhesion to the copper base material.

As mentioned above, ceramics advantageously do not have wettability with solder, but they do not adhere well to the base metal material. To solve this problem, the undercoating can be applied, as mentioned above. The following materials can be used as the undercoating:

| | Melting Point |
|---|---|
| | Degrees |
| Material | (Cent.) |
| Al₂O3—2.5% TiO₂ | 1855 |
| 70% Al₂O₃—29% MgO | 2135 |
| Cr₂O₃ | 2265 |
| 62% CaO—33% SiO₂ | 1900 |
| Al | 650 |
| Ni | 1456 |
| Cu | 1083 |
| Mo | 2622 |
| W | 3382 |
| Ti | 1820 |

Next, components of the soldering iron tip cap 130 are described. The Table below is a component table showing the content by weight (%) of the particles used in the manufacture of the metal particle sintered tip cap 130. The vertical axis of the Table shows “types” assigned to different combinations of particles. Here, eleven types have been given by way of example, but other preferred combinations may be used, within the scope of the invention. The horizontal axis shows the types of powders actually used in the composition of the metal powder sintered cap. Particle types can be broadly classified into sintering base materials and sintering additives. At least one of iron (Fe), nickel (Ni), and cobalt (Co) is chosen as the particles for the sintering base material. Types 9 through 11 use only a sintering base material. In Types 1 through 8, in addition to the sintering base material, sintering additive particles, chosen from at least one of copper (Cu), silver (Ag), tin (Sn), boron (B), and carbon (C) are used. In the top half of each row, the percent by weight of the various particles used, with respect to the total particles, is shown, and in the bottom half, the preferred ranges (omitted for Types 9 through 11) are shown in brackets.

TABLE

| | Basic Sintering Material | | | | Sintering Additive | | | | | |
|---|---|---|---|---|---|---|---|---|---|---|
| | Iron | nickel | cobalt | total basic | copper | silver | tin | boron | carbon | total additive |
| Type | (Fe) | (Ni) | (Co) | material | (Cu) | (Ag) | (Sn) | (B) | (C) | weight % |
| 1 | 93.2 | — | — | 93.2 | 5.5 | 1.3 | — | — | — | 6.8 |
| | (88-98.5) | | | (88-98.5) | (1.0-10.0) | (0.5-2.0) | | | | (1.5-12.0) |
| 2 | 74.0 | — | — | 74.0 | 24.0 | 11.0 | — | — | — | 35.0 |
| | (60-88) | | | (60-88) | (10-38) | (2.0-2.0) | | | | (12.0-40) |
| 3 | 90.7 | — | — | 90.7 | 5.5 | 1.3 | 2.5 | — | — | 9.3 |
| | (83-98.5) | | | (83-98.5) | (1.0-10.0) | (0.5-2.0) | (0-5.0) | | | (1.5-17) |
| 4 | 94.5 | 5.0 | — | 99.5 | — | — | — | 0.5 | — | 0.5 |
| | (89-99.99) | (0-10) | | (99-99.99) | | | | (0.01-1.0) | | (0.01-1.0) |
| 5 | 68.2 | 25.0 | — | 93.2 | 5.5 | 1.3 | — | — | — | 6.8 |
| | (38.0-98.5) | (0-50) | | (88-98.5) | (1.0-10.0) | (0.5-2.0) | | | | (1.5-12.0) |
| 6 | 83.2 | — | 10.0 | 93.2 | 5.5 | 1.3 | — | — | — | 6.8 |
| | (68-98.5) | | (0-20) | (88-98.5) | (1.0-10.0) | (0.5-2.0) | | | | (1.5-12.0) |
| 7 | 58.2 | 25.0 | 10.0 | 93.2 | 5.5 | 1.3 | — | — | — | 6.8 |
| | (18-98.5) | (0-50) | (0-20) | (88-98.5) | (1.0-10.0) | (0.5-2.0) | | | | (1.5-12.0) |
| 8 | 99.2 | — | — | 99.2 | — | — | — | — | 0.8 | 0.8 |
| | (98-99.7) | | | (98-99.7) | | | | | (0.3-2.0) | (0.3-2.0) |
| 9 | 100 | — | — | 100 | — | — | — | — | — | — |
| 10 | 58 | 42 | — | 100 | — | — | — | — | — | — |
| 11 | 54 | 28 | 18 | 100 | — | — | — | — | — | — |

For example, the components in Type 1 are 93.2% Fe/5.5% Cu/1.3% Ag. The preferred ranges for each of the components are Fe: 88-98.5%, Cu: 1-10%, Ag: 0.5-2%. The entries for Types 2-11 follow the same notation. The amounts of these particles used may be determined within the preferred range for each of the particles, but if a sintering additive is used, this is adjusted so that the total amount of the sintering base material is within the range of 60-99.99%, and the total amount of sintering additive is within the range of 0.01-40%. For example, the amounts of sintering additives in Type 2 may be determined within the ranges of Cu: 10-38% and Ag: 2-20%, but these are selected so that the totals thereof do not exceed 40%.

With regard to iron particles, which constitute a sintering base material, iron is an important (or indispensable) primary component for successful corrosion resistance. Consequently, iron particles are used in all of Types 1-11, and, in Type 9, only iron particles are used. However, as is also known from conventional iron-plating methods, impurities in iron negatively impact soldering performance; and therefore, iron powder having a purity of no less than 99.5% is used for the iron particles. When the iron particles have a high purity, losses in thermal and electrical conduction can be avoided, soldering performance improved, and the density of the metal particle sintered cap increased. If the iron particles contain large quantities of impurities, such as carbon (C), oxygen (O), nitrogen (N), or hydrogen (H), the corresponding density of the metal particle sintered body may be no greater than 90%, while in the present embodiment, which uses high-purity iron powder, the density is increased to no less than 96%.

Nickel particles and cobalt particles are also suitable choices as sintering base materials. Nickel and cobalt belong to the iron group, which is Group VIII of the Periodic Table. Accordingly, nickel particles and cobalt particles have similar characteristics to iron particles, and not only can they be used as a substitute material for iron, but characteristics superior to those of iron particles alone are demonstrated with certain combinations thereof. Nickel particles are used in Types 4, 5, and 10; cobalt particles are used in Type 6; and both are used in Types 7 and 11.

Fe—Ni sintered alloys, which use both iron particles and nickel particles as sintering base materials, produce sintered products with improved soldering performance, as compared with iron alone. In this case, the amount of nickel particles added is preferably no greater than 50%. If the amount of nickel particles exceeds 50%, the corrosion resistance is inferior and solder corrosion progresses rapidly.

Fe—Co sintered alloys, which use iron particles and cobalt particles as sintering base materials, promote sinterability and suppress solder corrosion. In this case, it is preferable that the amount of cobalt particles added be no greater than 20%. If 20% is exceeded, inferior soldering performance and increased cost result.

The use of 1-10% of copper particles as a sintering additive (Types 1, 3, 5, 6, and 7) not only improves solder wetting, but allows a high-density Fe—Cu sintered alloy to be produced due to liquid phase sintering, which is extremely efficient. Liquid phase sintering (in the case of copper) is a method wherein the sintering temperature is set to greater than the melting point of copper, which is 1083° C., so that the copper is liquefied during the sintering process. Preferably, 1-10% of copper particles are added; at less than 1%, the effect is small, and at greater than 10% when liquid phase sintering occurs, the formed product readily deforms as a result of local melting of the copper particles.

An Fe—Cu sintered alloy, in which greater than 10% of copper particles are added, may be used (Type 2). However, in this case, the temperature is set to less than the melting point of copper for the reasons given above. If prepared in this manner, while the corrosion resistance characteristics are slightly lowered, the thermal conductivity and the soldering performance are improved, making this suitable when soldering performance is more important than corrosion resistance. Furthermore, this Fe—Cu sintered alloy containing a large amount of copper particles is characterized by lesser decreases in thermal conductivity than solution alloys. For example, as compared to solution Fe-50% Cu alloys having an electrical conductivity of no greater than 20% IACS, these Fe—Cu sintered alloys show a high electrical conductivity of 50% IACS. This relationship is also proportional for thermal conductivity. It is preferable that no more than 40% of copper particles be added; generally if 40% is exceeded, solder corrosion increases.

If silver is used as a sintering additive (e.g., Types 1, 2, 3, 5, 6, and 7), a high-density Fe—Ag sintered alloy can be achieved as a result of liquid phase sintering at an even lower temperature than where copper particles alone are used. This is because the melting point of silver is lower than that of copper, at 960° C. Furthermore, in the Fe—Cu sintered alloy, having a large quantity of copper particles described above (Type 2), an Ag-28% Cu (eutectic temperature 780° C.) low melting point particle may be used. It is preferable that 0.5-20% of silver particles or silver-copper particles be added; if 20% is exceeded, production cost increases.

If tin particles are used as a sintering additive (Type 3), soldering performance is improved. Additionally, since tin has a low melting point of 232° C., liquid phase sintering can be achieved at an even lower temperature. In terms of adding tin particles in this manner, it is also effective to add copper particles and silver particles at the same time, as in Type 3. However, it is preferable to add no more than 5% of tin particles. If this amount is exceeded, the metal particle sintered body becomes weak as a result of compounds, such as FeSn₂, which are formed.

If boron particles are used as the sintering additive (Type 4), boron is interstitially diffused among the iron group elements, furthering mutual diffusion of the solids within each other, allowing sintering at the relatively low temperature of 1100° C. Adding a small amount of boron particles has the advantage of having substantially no negative effect on soldering performance, and it is preferable that 0.01-1% be added. At percentages less than this, the effect is small, and if the upper end of the range is exceeded, the soldering performance tends to deteriorate. In addition to adding boron particles alone, particles of alloys containing boron, such as Fe—B particles, Ni—B particles, or Cu—B particles, may be added.

If approximately 0.8% of carbon particles are used as a sintering additive (Type 8), the corrosion resistance of the soldering iron tip cap is greatly improved, and the life thereof can be greatly extended.

The metal particles used for the sintering base materials and the sintering additives described above suitably have a particle size of no greater than two hundred μm, preferably no greater than fifty μm; and still more preferably, they are ultrafine particles (that is, nano particles). By using such small metal particles, the density of the metal particle sintered body can be increased as well as the corrosion resistance and soldering performance.

A method of manufacturing the soldering iron tip cap is now described. In a first step, the sintering base material, the sintering additive, and a binder (additive agent) are mixed in a mixer. In a second step, this mixture is pressure molded in a press mold, an injection mold, or the like, to form a green compact (shaping). The shape of the green compact is roughly similar to the shape of the soldering iron tip cap. Thereafter, the green compact is removed from the mold; and in a third step, the green compact is sintered in a non-oxidative atmosphere at a predetermined temperature (800-1300° C.) to form a metal particle sintered body. In a fourth step, this body is machined to match to the soldering iron tip and to complete the soldering iron tip cap.

Sintering the soldering iron tip cap using powder metallurgy provides flexibility in its shaping, and allows a shape to be produced which is close to the final shape, so that final grinding procedures can be reduced or even eliminated. Furthermore, as compared to solution processes, it is not necessary to heat the green compact to the melting point of iron, which reduces the amount of energy used and the environmental impact. Thus, since discharge processing, such as when conventional iron plating was used, is not necessary, environmental damage is reduced, allowing for energy savings and mass production.

The molding indicated in the second step can be pressureless molding, wherein pressure is not applied. On the other hand, pressure molding increases the density of the green compact, which allows for an increase in the density of the sintered metal particle sintered body. Then, if liquid phase sintering is used, it is possible to achieve a metal particle sintered body with an even higher density. Liquid phase sintering is a method wherein particles are used for the sintering additive, which has a relatively low melting point (copper particles, silver particles, Ag-28% Cu eutectic particles (eutectic temperature 780° C.), tin particles, and the like), and sintering is performed at temperatures higher than these melting points.

When sintering additive particles are mixed into the sintering base material particles before pressure is applied, relatively large gaps are formed. After the pressure molding the sintering base material particles and the sintering additive particles are plastically deformed so as to be flattened, bringing the particles into close contact with each other but leaving small gaps. After liquid phase sintering, as a result of recrystalization, the sintering base material particles grow, and the gaps are filled by the sintering additive particles, which increases fineness. The reason for this is that, in addition to the solid state diffusion of the base material particles themselves, the sintering additive particles melt at the sintering temperature, wetting the sintering base material particles, while at the same time the gaps are filled by this liquid as a result of surface tension. In addition to producing such high-density metal particle sintered bodies, liquid phase sintering allows for sintering at relatively lower temperatures, thereby saving energy.

Furthermore, after sintering the metal particle sintered body, the body can be further shaped by preform forging or powder forging at 300-500° C. to produce the soldering iron tip cap, as would be apparent to those skilled in the art from this disclosure. By using these methods, the fine gas cavities between the particles can be reduced and the particle density thereby increased.

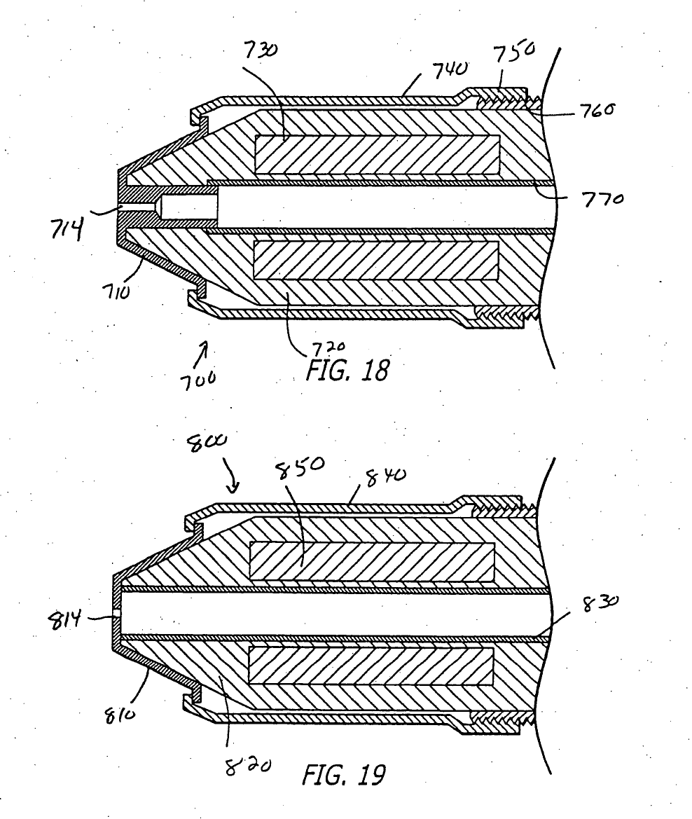

The replaceable tip cap invention concept can be used for both soldering and desoldering iron tools. Examples of their use for desoldering tools are shown in FIGS. 18 and 19. Shown in FIG. 18, is a desoldering iron 700 including a tip cap 710 (having a central opening 714), a heating core 720 (which includes the working end), the heater and sensor 730, the fixing pipe or sleeve 740, the nut 750, the threaded member 760 (integrally formed with the sleeve), the stainless steel suction pipe 770 through which suction force is applied through a filter (not shown) by means of a vacuum pump (also not shown). An alternative embodiment is shown generally at 800 in FIG. 19. Referring thereto, the tip cap 810, the core 820, the stainless steel suction pipe 830, the sleeve 840, and the sensor and heater 850 are shown. Reference is made to U.S. Pat. No. 4,997,121 (Yoshimura).

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thererof.

1. A soldering iron heating system, comprising:
an elongate heating assembly including a heating tip;
a tip cap releasably held on the heating tip; and
heat conducting material sandwiched between the heating tip and the tip cap and adapted to allow the tip cap to be removed from the heating tip after soldering use for tip cap replacement.

2. The system of claim 1 wherein the heating assembly includes a heater unit and a temperature sensor.

3. The system of claim 1 wherein the heating assembly includes a heat conductive core, and the core includes the heating tip.

4. The system of claim 1 wherein the heating assembly includes a central circumferential handle grip.

5. The system of claim 1 wherein the heating tip has a bevel, conical, chisel or knife shape, and the tip cap has a shape corresponding thereto.

6. The system of claim 1 further comprising a connector assembly having a forward end, and the heating assembly being releasably and operatively connectable to the forward end to provide power to a heater unit of the heating assembly.

7. The system of claim 6 wherein the heating assembly is connectable to the connector assembly using an O-ring snap-fit connection.

8. The system of claim 1 wherein the tip cap is a metal particle sintered tip cap.

9. The system of claim 8 wherein the metal particle sintered tip cap includes a metal particle sintering base material or a sintering base material and a sintering additive.

10. The system of claim 9 wherein the sintering base material includes at least one of iron particles, nickel particles and cobalt particles.

11. The system of claim 9 wherein the sintering additive is at least one of silicon particles, copper particles, silver particles, tin particles, boron particles, ceramic particles and carbon particles.

12. The system of claim 1 wherein the heating tip includes a core and a top coating, wherein the top coating is not meltable by solder.

13. The system of claim 12 wherein the top coating is a ceramic material, a cement material or a metal.

14. The system of claim 13 wherein the heating tip includes an undercoating between the top coating and the core, the undercoating having a heat expansion rate which is greater than that of the top coating and less than that of the core.

15. The system of claim 1 wherein the core is copper or a copper alloy.

16. The system of claim 1 wherein the tip cap is made of Fe-2 wt. % to 50 wt. % Ni.

17. The system of claim 1 wherein the tip cap is made of Fe-10 wt. % Ni.

18. The system of claim 1 wherein the tip cap is made of Fe-0.5 to 10 wt. % Cu-0.1 to 5 wt. % Ni-0.1 to 1.0 wt. % Ag alloy.

19. The system of claim 1 wherein the tip cap is made of Fe-1 wt. % Cu-0.4 wt % Ni-0.3 Ag.

20. The system of claim 1 wherein the tip cap is made of Fe-0.05 to 1 wt. % C.

21. The system of claim 1 wherein the tip cap is made of Fe-0.4 wt. % C.

22. The system of claim 1 wherein the conducting material is a metal whose melting temperature is below approximately 350° C.

23. The system of claim 22 wherein the melting temperature is between approximately 100° C. and approximately 350° C.

24. The system of claim 22 wherein the metal is a solder.

25. The system of claim 22 wherein the metal is bismuth or lead.

26. The system of claim 22 wherein the metal is Sn-9Zn.

27. The system of claim 22 wherein the conducting material is a powder having a heat conductivity of at least 0.01 (0.4814W/mK).

28. The system of claim 27 wherein the heat conductivity is between 0.01 and 1.0 (0.4814W/mK).

29. The system of claim 1 wherein the conducting material is a powder having a particle size between one and twenty micrometers.

30. The system of claim 29 wherein the powder is carbon, aluminum, copper or silver.

31. The system of claim 1 wherein the conducting material is a gel.

32. The system of claim 31 wherein the gel includes an organic solvent.

33. The system of claim 32 wherein the organic solvent is alcohol, oil, flux or paraffin wax.

34. The system of claim 1 wherein the conducting material is a paste solder.

35. The system of claim 1 wherein the conducting material is adapted to be in a solid state during the soldering use of the soldering iron heating system at temperatures of approximately between 200 and 450° C.

36. The system of claim 1 wherein the conducting material is adapted to be in a melted state during soldering use of the soldering iron heating system at temperatures of approximately between 200 and 450° C.

37. The system of claim 36 wherein the conducting material that is in a melted state during use is selected from the group of Sn, Sn-37Pb, Bi, Sn-0.7 Cu, Sn-3.5 Ag-0.7 Cu, Sn-9Zn, Sn-58Bi, In, and Pb.

38. The system of claim 36 wherein the conducting material that is in a melted state during use is Bi or In.

39. The system of claim 36 wherein the conducting material that is in a melted state during use is a line solder or a paste solder.

40. The system of claim 1 wherein the tip cap comprises an iron metal or an iron-nickel alloy.

41. The system of claim 1 wherein the tip cap comprises an iron-copper-nickel-silver alloy.

42. The system of claim 1 wherein the tip cap comprises an iron-carbon alloy.

43. The system of claim 1 wherein the tip cap is a metal injection molded construction.

44. The system of claim 1 wherein the conducting material is in an amount between 0.01 gram to 10 grams.

45. The system of claim 44 wherein the amount of the conducting material is between 0.1 and 1.0 gram.

46. The system of claim 1 wherein the tip cap is adapted to be used at operating temperatures of approximately 250° C. to 450° C.

47. The system of claim 1 wherein the tip cap has a length of between 5 mm and 20 mm.

48. The system of claim 1 wherein the tip cap has a base opening whose diameter is between 2 mm to 10 mm.

49. The system of claim 1 wherein the tip cap has a wall thickness of between 200 micrometers and 800 micrometers.

50. The system of claim 1 wherein the tip cap has tin plating or solder plating on a forward end thereof.

51. The system of claim 50 wherein the tin plating or solder plating extends rearward 1 mm to 10 mm from a forward end of the tip cap.

52. The system of claim 51 wherein the tin plating or solder plating extends approximately 4 mm from the forward end.

53. The system of claim 50 wherein the tip cap has chromium plating on the remainder of its exterior surface proximal to the tin plating or solder plating.

54. The system of claim 1 wherein the tip cap is a chisel-type tip cap and has a tin plating or solder plating of approximately 4 mm from its tip and a chromium plating of 6 mm from the tin plating to the proximal end of the tip cap.

55. The system of claim 1 wherein the tip cap is a chisel-type tip cap having a base opening inner diameter of approximately 4 mm and a flanged base having an outer diameter of approximately 5 mm.

56. The system of claim 1 wherein the tip cap is a conical-type tip cap having tin plating or solder plating extending approximately 6.5 mm from the tip and chromium plating rearwardly 0.5 mm therefrom.

57. The system of claim 1 wherein the tip cap is a conical-type tip cap having an opening at its base having an inner diameter of approximately 2.5 mm and a flanged base having an outer diameter of approximately 3.5 mm.

58. The system of claim 1 wherein the tip cap has a connector flange at a proximal end thereof adapted to at least in part releasably connect the tip cap to the heating assembly and on the heating tip.

59. The system of claim 1 further comprising a threaded member connected to the heating assembly, and a threaded nut adapted to thread onto the threaded member to releasably hold the tip cap on the heating tip.

60. The system of claim 1 further comprising a connector sleeve adapted to releasably connect the tip cap to the tip.

61. The system of claim 60 wherein the sleeve has a proximal flange.

62. The system of claim 60 wherein the sleeve is affixed at a distal end thereof to the tip cap.

63. The system of claim 60 wherein the sleeve has at least one longitudinal slot engaging a proximal end of the sleeve.

64. The system of claim 60 wherein the sleeve has an inwardly disposed lip at a distal end thereof adapted to engage a flange of the tip cap.

65. The system of claim 60 further comprising a coil spring around a proximal end of the sleeve.

66. The system of claim 1 further comprising a coil spring attached at a distal end thereof to a proximal end of the tip cap.

67. The system of claim 66 wherein the heating assembly includes an angled slot adapted to releasably receive therein a proximal end of the coil spring in a tip cap holding position.

68. The system of claim 1 further comprising: the heating assembly including an angled slot; a compressible member connected to the tip cap; a rearward tab connected to the compressible member; and the tab being adapted to fit into the angled slot into a holding position when the compressible member is in a compressed position and releasably holding the tip cap on the tip when the compressible member is released from the compressed position.

69. The system of claim 68 wherein the compressible member is a coil spring.

70. The system of claim 69 wherein the tab is a proximal end of the coil spring.

71. The system of claim 1 wherein the tip cap has a base ring flange.

72. The system of claim 1 further comprising a sleeve having an inward lip at a distal end thereof adapted to releasably engage a rearward end of the tip cap and a clamping ring at a proximal end thereof adapted to releasably thread onto the heating assembly.

73. A soldering iron heating system, comprising:
an elongate heating assembly including a heating tip;
a tip cap releasably held on the heating tip; and
conducting means sandwiched between the heating tip and the tip cap for conducting heat from the heating tip to the tip cap and for allowing the tip cap to be removed from the heating tip after soldering use thereof for tip cap replacement.

74. The system of claim 73 wherein the conducting means is a solid material, a powder or a gel.

75. The system of claim 73 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

76. A soldering iron heating system, comprising:
an elongate heating assembly including a heating tip;
a tip cap releasably held on the heating tip; and
the tip cap having a connector flange at a proximal end thereof adapted to releasably connect the tip cap to the heating tip.

77. The system of claim 76 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

78. A soldering iron heating system, comprising:
an elongate heating assembly including a heating tip;
a tip cap releasably held on the heating tip;
a threaded member connected to the heating assembly; and
a threaded nut adapted to thread onto the threaded member to releasably hold the tip cap on the heating tip.

79. The system of claim 78 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

80. A soldering iron heating system, comprising:
an elongate heating assembly including a heating tip;
a tip cap releasably held on the heating tip; and
a connector sleeve adapted to releasably connect the tip cap to the tip.

81. The system of claim 80 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

82. The system of claim 80 wherein the sleeve has a proximal flange.

83. The system of claim 80 wherein the sleeve is affixed at a distal end thereof to the tip cap.

84. The system of claim 80 wherein the sleeve has at least one longitudinal slot engaging a proximal end of the sleeve.

85. The system of claim 80 wherein the sleeve has an inward lip at a distal end thereof adapted to engage a flange of the tip cap.

86. The system of claim 80 further comprising a coil spring around an aft end of the sleeve.

87. A soldering iron heating system, comprising:
an elongate heating assembly including a heating tip;
a tip cap releasably held on the heating tip; and
a coil spring attached at a distal end thereof to a proximal end of the tip cap.

88. The system of claim 87 wherein the heating assembly includes an angled slot adapted to releasably receive therein a proximal end of the coil spring.

89. The system of claim 87 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

90. A soldering iron heating system, comprising:
an elongate heating assembly including a heating tip;
a tip cap releasably held on the heating tip;
the heating assembly including an angled slot;
an elongate compressible member connected to the tip cap;
a tab connected to the compressible member; and
the tab is adapted to fit into the angled slot into a holding position when the compressible member is in a compressed position and releasably holding the tip cap on the tip when the compressible member is released from the compressed position.

91. The system of claim 90 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

92. The system of claim 91 wherein the heating assembly includes a collar and the angled slot being formed in the collar.

93. The system of claim 91 wherein the compressible member is a coil spring.

94. The system of claim 93 wherein the tab is a rear end of the coil spring.

95. A soldering iron heating system, comprising:
an elongate heating assembly including a heating tip;
a tip cap releasably held on the heating tip; and
the tip cap having a base ring flange adapted to connect to means for releasably holding the tip cap on the heating tip.

96. The system of claim 95 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

97. A soldering iron heating system, comprising:
an elongate heating assembly including a heating tip;
a tip cap releasably held on the heating tip; and
a sleeve having an inward lip at a distal end thereof adapted to releasably engage a rearward end of the tip cap and a clamping ring at a proximal end thereof adapted to releasably thread onto the heating assembly.

98. The system of claim 97 wherein the heating assembly includes a heating unit, a temperature sensor and a core, and wherein the core includes the heating tip, and further comprising means for electrically connecting an aft end of the heating assembly to an electrical connector and for allowing the heating assembly to be disconnected therefrom for replacement purposes.

99. A soldering iron system, comprising:
a replaceable heating unit including a heater, a temperature sensor, rearward end and a forward working end;
an electrical power connector member;
connecting means for replaceably connecting the rearward end to the connector member and providing electrical connection therebetween;
a replaceable tip cap;
heat conducting material; and
holding means for releasably holding the tip cap on the working end with the conducting material sandwiched therebetween.

100. The system of claim 99 wherein the conducting material is in a solid state during soldering use of the tip cap and the heating unit.

101. The system of claim 99 wherein the conducting material is in a melted state during soldering use of the tip cap and the heating unit.

102. The system of claim 99 wherein the tip cap has a body portion and an outward flange at a base of the body portion.

103. The system of claim 102 wherein the flange extends around an entire periphery of the base.

104. The system of claim 102 wherein the flange and the body portion are integrally formed.

105. The system of claim 99 wherein the tip cap is a metal injection molded construction.

106. The system of claim 99 wherein the tip cap has tin plating or solder plating at a forward tip end thereof.

107. The system of claim 106 wherein the tip cap has chromium plating at a rearward surface rearward of the tin plating or solder plating.

108. The system of claim 99 wherein the connecting means includes at least one O-ring.

109. The system of claim 99 wherein the heating unit includes a rod extending rearward of the forward tip.

110. The system of claim 99 wherein the heating unit includes a circumferential handle grip.

111. The system of claim 99 wherein the holding means includes a sleeve encircling the rod and connected at a forward end to the tip cap.

112. The system of claim 111 wherein the sleeve is a solid pipe.

113. The system of claim 111 wherein the sleeve is a longitudinally compressible sleeve.

114. The system of claim 113 wherein the longitudinally compressible sleeve is a coil spring.

115. The system of claim 111 wherein the sleeve is a radially-gripping split sleeve.

116. The system of claim 111 wherein the sleeve is affixed at a forward end thereof to a rearward end of the tip cap to form a single piece.

117. The system of claim 111 wherein the sleeve is releasably engaged with the tip cap.

118. The system of claim 111 wherein the cap has a base flange and the sleeve has at a rearward end inward tab which engages the flange.

119. The system of claim 111 wherein the holding means includes a compression spring at a rear end of the sleeve.

120. The system of claim 111 wherein the holding means includes slot means for receiving a tab end of the sleeve.

121. The system of claim 109 wherein the holding means includes a threaded means on the rod and a nut adapted to thread on the threaded means.

122. The system of claim 99 wherein the tip cap is an iron metal or an iron-nickel alloy.

123. The system of claim 99 wherein the tip cap is an iron-copper-nickel-silver alloy.

124. The system of claim 99 wherein the tip cap is an iron-carbon alloy.

125. A removable soldering iron tip cap, comprising:
a body portion having a closed top and an open base; and
a flange extending out from the base.

126. The tip cap of claim 125 wherein the flange extends radially about an entire circumference of the open base.

127. The tip cap of claim 125 wherein the flange extends out approximately 1 mm from the body portion.

128. The tip cap of claim 125 wherein the flange is integrally formed with the body portion.

129. The tip cap of claim 125 wherein the body portion is a metal injection molded component.

130. The tip cap of claim 125 wherein the body portion is made of an iron metal.

131. The tip cap of claim 125 wherein the body portion is made of an iron-nickel alloy.

132. The tip cap of claim 125 wherein the body portion is made of an iron-copper-nickel-silver alloy.

133. The tip cap of claim 125 wherein the body portion is made of an iron-carbon alloy.

134. The tip cap of claim 125 wherein the body portion is made of a metal injection molded construction.

135. The tip cap of claim 125 wherein the body portion is made of a pressed metal construction.

136. The tip cap of claim 125 wherein the body portion is adapted to be used at operating temperatures of approximately 300° C. to 400° C. in soldering operations.

137. The tip cap of claim 125 wherein the body portion has a length of between 5 mm and 20 mm.

138. The tip cap of claim 125 wherein the open base has an inner diameter of between 2 mm to 10 mm.

139. The tip cap of claim 125 wherein the body portion has a wall thickness of between 200 micrometers and 800 micrometers.

140. The tip cap of claim 125 wherein the body portion has a tin plating or solder plating at an outside forward end thereof.

141. The tip cap of claim 140 wherein the tin plating or solder plating extends rearward 1 mm to 10 mm from a distal point of the body portion.

142. The tip cap of claim 141 wherein the tin plating or solder plating extends approximately 4 mm from the distal point.

143. The tip cap of claim 140 wherein the body portion has chromium plating on the remainder of its exterior surface rearward of the tin plating or solder plating.

144. The tip cap of claim 143 wherein the flange has chromium plating.

145. The tip cap of claim 125 wherein the body portion has a chisel-type shape, a conical shape, a knife shape, or a bevel shape.

146. The tip cap of claim 125 wherein the open base has an inner diameter of approximately 4 mm and the flange has an outer diameter of approximately 5 mm.

147. The tip cap of claim 125 wherein the body portion has a coating of a heat conducting material on its entire inside surface.

148. The tip cap of claim 125 further comprising a coil spring secured to the flange and extending rearwardly therefrom.

149. The tip cap of claim 125 further comprising a sleeve attached to the flange and extending rearwardly therefrom.

150. The tip cap of claim 149 wherein the sleeve has at least one longitudinal slot engaging a rearward end thereof.

151. A removable, soldering iron tip cap, comprising:
a body portion having a closed top and an open base; and
a coil spring attached to the body portion and extending rearwardly therefrom, wherein the coil spring is aligned with a longitudinal axis of the body portion.

152. The tip cap of claim 151 wherein the coil spring is attached to the body portion by a weld.

153. The tip cap of claim 151 further comprising a flange extending out from the base and to which the coil spring is attached.

154. A removable soldering iron tip cap, comprising:
a body portion having a closed top and an open base; and
a sleeve attached at a forward end thereof to the open base and extending rearwardly therefrom.

155. The tip cap of claim 154 wherein the sleeve is formed of a stainless steel material.

156. The tip cap of claim 154 further comprising a flange attached to the body portion and having a longitudinal axis aligned with a longitudinal axis of the sleeve.

157. A method of assembling a soldering iron, comprising:
applying heat conducting material on an interior surface of a soldering iron tip cap; and
after the applying, releasably fitting the tip cap onto a heat conducting working end of a soldering iron with the conducting material sandwiched between the tip cap and the working end.

158. The method of claim 157 wherein the applying includes applying the conducting material from a squeeze tube.

159. The method of claim 157 wherein the applying includes applying the material from an injection syringe.

160. The method of claim 157 wherein the applying includes applying the conducting material from a dropper.

161. The method of claim 157 wherein the applying includes applying the conducting material using a swab.

162. The method of claim 157 wherein the applying includes applying the conducting material in a powder state.

163. The method of claim 157 wherein the applying includes applying the conducting material in a tablet form.

164. The method of claim 157 wherein the fitting includes attaching a rearward end of a coil spring, whose forward end is connected to the tip cap, to structure on the heating assembly.

165. The method of claim 157 wherein the fitting includes threading a nut onto a sleeve.

166. The method of claim 157 wherein the fitting includes sliding an expandable grip sleeve onto the forward end of the heating assembly.

167. A method of using a soldering iron, comprising:
connecting a rear end of a heating unit to an electrical connector, the heating unit including a heater, a temperature sensor and a forward working end; and
releasably attaching a soldering tip cap to the working end.

168. The method of claim 167 wherein the attaching includes heat conducting material being sandwiched between the tip cap and the working end.

169. The method of claim 168 further comprising before the attaching, inserting the conducting material into the tip cap.

170. The method of claim 169 wherein the inserting includes using a squeeze container, a syringe, a dropper, or a swab.

171. The method of claim 169 wherein the inserting includes inserting the conducting material in solid form, powder form, or gel form.

172. The method of claim 167 wherein the connecting includes snap-fit connecting the rear end to the electrical connector.

173. The method of claim 167 further comprising after the connecting and after a first plurality of soldering uses of the soldering iron, disconnecting the heating unit from the electrical connector, and after the disconnecting connecting a replacement heating unit to the electrical connector.

174. The method of claim 167 wherein the first plurality of soldering uses is between approximately 10,000 and 40,000 point soldering uses.

175. The method of claim 173 further comprising after the connecting the rear end and before the connecting the replacement heating unit, removing the soldering iron tip from the working end after a second plurality of soldering uses, and after the removing, releasably attaching a replacement soldering iron tip to the working end.

176. The method of claim 175 wherein the second plurality of soldering uses is between approximately 10,000 and 40,000 point soldering uses.

177. The system of claim 1 wherein the heating assembly includes a suction passageway, and the tip cap includes a central opening communicating with the passageway when the tip cap is held on the heating tip whereby the tip cap is a desoldering iron tip cap.

178. The system of claim 73 wherein the heating assembly includes a suction passageway, and the tip cap includes a central opening communicating with the passageway when the tip cap is held on the heating tip, whereby the tip cap is a desoldering iron tip cap.

179. The system of claim 77 wherein the heating assembly includes a suction passageway, and the tip cap includes a central opening communicating with the passageway when the tip cap is held on the heating tip, whereby the tip cap is a desoldering iron tip cap.

180. The system of claim 78 wherein the heating assembly includes a suction passageway, and the tip cap includes a central opening communicating with the passageway when the tip cap is held on the heating tip, whereby the tip cap is a desoldering iron tip cap.

181. The system of claim 80 wherein the heating assembly includes a suction passageway, and the tip cap includes a central opening communicating with the passageway when the tip cap is held on the heating tip, whereby the tip cap is a desoldering iron tip cap.

182. The system of claim 87 wherein the heating assembly includes a suction passageway, and the tip cap includes a central opening communicating with the passageway when the tip cap is held on the heating tip, whereby the tip cap is a desoldering iron tip cap.

183. The system of claim 90 wherein the heating assembly includes a suction passageway, and the tip cap includes a central opening communicating with the passageway when the tip cap is held on the heating tip, whereby the tip cap is a desoldering iron tip cap.

184. The system of claim 95 wherein the heating assembly includes a suction passageway, and the tip cap includes a central opening communicating with the passageway when the tip cap is held on the heating tip, whereby the tip cap is a desoldering iron tip cap.

185. The system of claim 97 wherein the heating assembly includes a suction passageway, and the tip cap includes a central opening communicating with the passageway when the tip cap is held on the heating tip, whereby the tip cap is a desoldering iron tip cap.

186. The system of claim 99 wherein the heating unit includes a suction passageway, and the tip cap includes a central opening communicating with the suction passageway when the holding means is holding the tip cap on the working end whereby the tip cap is a desoldering iron tip cap.

187. The tip cap of claim 125 wherein the closed top has a central through-opening whereby the tip cap is a desoldering iron tip cap.

188. The method of claim 157 wherein the tip cap has a central opening, the soldering iron has a suction passageway and the fitting communicates the opening with the passageway whereby the tip cap is a desoldering iron tip cap.
